(19) United States
(12) Patent Application Publication
(10) Pub. No.: US 2010/0094798 A1
(43) Pub. Date: Apr. 15, 2010

(54) ANOMALY DIAGNOSIS SYSTEM FOR PASSENGER CONVEYORS

(75) Inventors: Tadashi SHUDO, Asaka-shi (JP); Masaki Sakurai, Chiba-shi (JP); Yasuaki Takeda, Tokyo (JP)

Correspondence Address: FOLEY AND LARDNER LLP;SUITE 500, 3000 K STREET NW, WASHINGTON, DC, 20007, US

(73) Assignee: TOSHIBA ELEVATOR KABUSHIKI KAISHA

(21) Appl. No.: 12/500,169

(22) Filed: Jul. 9, 2009

(30) Foreign Application Priority Data
Jul. 10, 2008 (JP) 2008-180044

(51) Int. Cl. G06N 5/02

(52) U.S. Cl. 706/54

(57) ABSTRACT

Escalator operation sounds are collected by a remote sound-collecting device 15 or fixed sound-collecting devices 17 and 18, and stored in a data collecting device 21 of a diagnosis device 20. A processing device 22 extracts only abnormal sound components of the escalator operation sound by calculation of a difference between reference data and the sound data stored in the data collecting device 21. The processing device 22 determines an occurrence of an anomaly based on whether a maximum peak P of the abnormal sound components is higher than a predetermined threshold value Sh1. When determined that the anomaly has occurred, the processing device 22 investigates a correlation between a frequency analysis result on data around the maximum peak of the abnormal sound components and abnormal sound frequency patterns pre-stored by causes of anomalies, and estimates the cause of the anomaly based on the investigation.

### CROSS REFERENCE TO RELATED APPLICATION

This application claims benefit of priority under 35 USC 119 based on Japanese Patent Application P2008-180044 filed Jul. 10, 2008, the entire contents of which are incorporated by reference herein.

### BACKGROUND OF THE INVENTION

1. Field of the Invention

The present invention relates to an anomaly diagnosis system for a passenger conveyor such as an escalator, a moving walkway or the like.

2. Description of the Related Art

A passenger conveyor such as an escalator or a moving walkway is to convey passengers on numerous steps connected to each other in an endless manner by circulating the steps along guide rails provided inside a truss.

If the above-described passenger conveyor has a trouble a period of the time is required to repair, thereby causing inconvenience to users. For this, it has been expected to detect an anomaly immediately when the anomaly occurs before a failure, and to remove the anomaly by maintenance operation or the like.

Against the background, Japanese Patent Application Laid-Open Publication No. 2007-8709 (Patent Document 1) discloses a technique for judging where an anomaly occurs in a passenger conveyor. In this technique, a diagnosis device having a acceleration sensor or microphone is provided in a step which is circulated. Further, a statistical characteristic value is calculated by processing signals detected by the acceleration sensor or microphone, and this value is compared with a predetermined characteristic value to determine whether the anomaly occurs in the passenger conveyor. According to the technique of the Patent Document 1, automatic diagnosis is possible since the occurrence of the anomaly can be determined with excluding external disturbances suddenly occurred.

### SUMMARY OF THE INVENTION

In the technique of the Patent Document 1, the automatic determination for the occurrence of an anomaly is possible, but identification of the cause thereof is impossible. Accordingly, when the anomaly is found in the passenger conveyor, the maintenance worker has to visit the installation site to investigate the condition of the passenger conveyor and to specify the cause. In this way, specifying the cause requires a long period of the time. Further, it has been difficult to select the suitable maintenance workers and the numbers thereof before sending them to the site. The above problems have interrupted the efficient maintenance operation.

The present invention has been made in view of these problems in the related art. An object of the present invention is to provide an anomaly diagnosis system for a passenger conveyor capable of achieving an effective maintenance operation not only by determination of an anomaly in the passenger conveyor, but also by automatic estimation of the cause thereof.

An aspect of the present invention is a anomaly diagnosis system for a passenger conveyor comprising: a sound-collecting device configured to collect a passenger conveyor operation sound; a determining device configured to determine whether an anomaly occurs using a passenger conveyor operation sound collected by the sound-collecting device; and an cause estimation device configured to estimate a cause of the anomaly. The determining device stores a standard sound data obtained from a passenger conveyor operation sound in normal operation, and determines whether an anomaly occurs based on a difference between the standard sound data and a sound data of a passenger conveyor operation sound collected by the sound-collecting device. The cause estimation device has frequency patterns indicating specific frequency components of abnormal sounds by factors causing the abnormal sounds, and estimates a cause of the anomaly by comparing a frequency analysis result from the difference between the standard sound data and a sound data of the passenger conveyor operation sound collected by the sound-collecting device with the frequency patterns of the abnormal sounds.

According to the present invention, it is possible both to automatically determine the occurrence of the anomaly in the passenger conveyor and to automatically estimate the cause of the anomaly, thereby achieving efficient maintenance operations.

### BRIEF DESCRIPTION OF THE DRAWINGS

FIG. 1 is a schematic diagram showing an anomaly diagnosis system according to an embodiment of the present invention.

FIG. 2 is a flowchart showing processes performed in the anomaly diagnosis system according to the embodiment of the present invention.

FIGS. 3A and 3B are schematic diagrams for explanation on a determination process of an anomaly according to the embodiment of the present invention; FIG. 3A shows sound data of an escalator operation sound; FIG. 3B shows a waveform of an abnormal sound component extracted from the sound data of the escalator operation sound.

FIG. 4 is a diagram for explanation on a determination process of an anomaly according to the embodiment of the present invention, the diagram showing comparison of a maximum peak with a threshold value.

FIG. 5 is a diagram for explanation on an estimation process of the cause of the anomaly according to the embodiment of the present invention.

FIG. 6 is a diagram for explanation on a determination process of the anomaly according to an embodiment of the present invention, the diagram showing a frequency analysis for the sound data of the escalator operation sound by predetermined time divisions.

FIG. 7 is a diagram for explanation on a determination process of the anomaly according to an embodiment of the present invention, the diagram showing extraction of a frequency characteristic of an abnormal sound component from that of the escalator operation sound and comparison of a maximum frequency peak with a threshold value.

### DESCRIPTION OF THE PREFERRED EMBODIMENT

Now, concrete embodiments according to the present invention will be described below in detail with reference to the accompanying drawings. The following embodiments will describe an escalator configured to move numerous steps obliquely between a lower floor and an upper flower. However, the present invention is also applicable to a moving walkway configured to move numerous steps continuously in a horizontal direction.

### First Embodiment

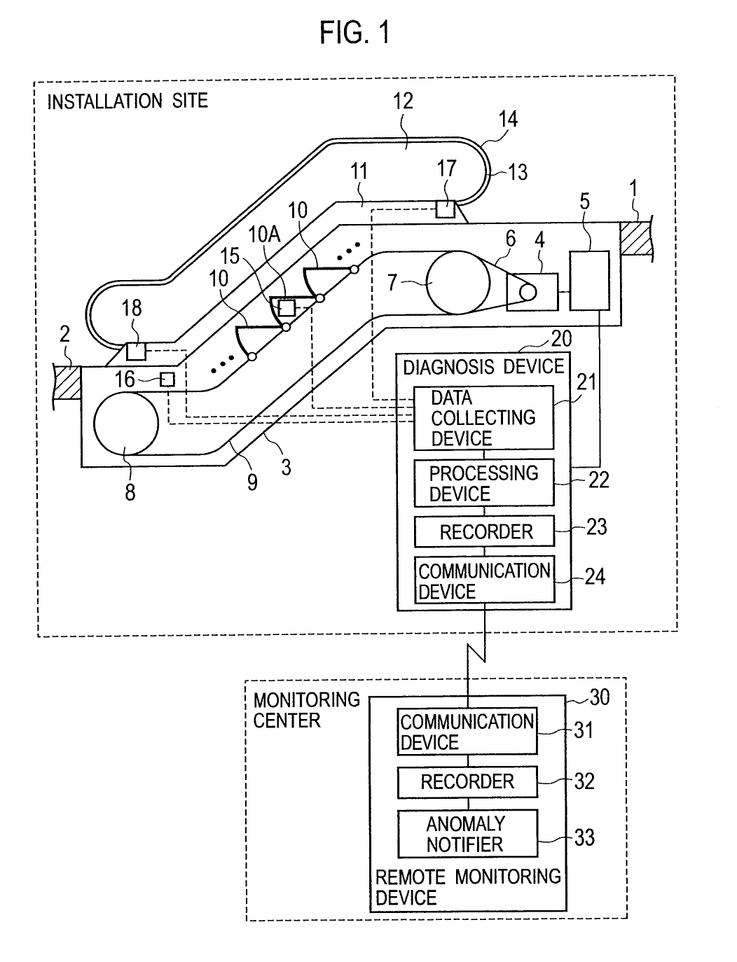

FIG. 1 is a diagram schematically showing an overall configuration of an anomaly diagnosis system employing the present invention. As shown in FIG. 1, an escalator as a diagnosis target is supported by a truss 3 that is fixed to an upper floor beam 1 and a lower floor beam 2 of the building for installation therebetween. Inside the truss 3, a driving device 4 and controller 5 are disposed on the side of the upper floor beam 1. The driving device 4 drives a driving sprocket 7 via a driving chain 6 under control of the controller 5. Additionally, inside the truss 3, a driven sprocket 8 constituting a pair with the driving sprocket 7 is disposed on the side of the lower floor beam 2. A chain 9 is wound around the driving sprocket 7 and the driven sprocket 8. The chain 9 circulates between the driving sprocket 7 and driven sprocket 8 by rotation of the driving sprocket 7 which is driven by the driving device 4. Consequently, the numerous steps 10 connected to one another with the chain 9 are configured to circulate along a guide rail (not shown) between the platform on the upper floor side and the platform on the lower floor side with circulation of the chain 9.

Balustrades 13 are provided upright on the left and right sides of the steps 10 to be circulated. Each balustrade 13 is composed of a deck board 11 and balustrade panel 12. Handrail belts 14 are fitted around the balustrades panels 12. The handrail belt 14 is a railing to be grasped by a passenger on the step 10, which is circulated on the periphery of the balustrade panel 12 synchronously with the motion of the steps 10 by transmitting the above-mentioned drive force from the driving device 4, for example.

In the escalator configured as described above, at least one of the numerous steps 10 to be circulated is configured to be an inspection step 10A in order to allow diagnosis by the anomaly diagnosis system of this embodiment. Moreover, a mobile sound-collecting device 15 is disposed inside this inspection step 10A. The mobile sound-collecting device 15 is configured to collect an escalator operation sound while being circulated together with the inspection step 10A. Further, a position detecting device 16 is disposed at a predetermined position (reference position) in the circulation path of the numerous steps 10 including the inspection step 10A. The position detecting device 16 is configured to output a detection signal when the inspection step passes through the reference position. The position of the inspection step 10A including the mobile sound-collecting device 16 therein is recognized by confirming the output timing of the detection signal from the position detecting device 16.

As a device for collecting escalator operation sounds, for example, fixed sound-collecting devices 17 and 18 will be used in addition to the mobile sound-collecting device 15 housed in the inspection step 10A, if required. These fixed sound-collecting devices 17 and 18 collect the escalator operation sounds at predetermined fixed points.

In the installation site of the escalator being the diagnosis target, there is provided a diagnosis device 20 having: a data collection device 21, processing device 22, recorder 23 and communication device 24. Meanwhile, a remote monitoring device 30 is disposed in a monitoring center which is located in a remote place away from the escalator installation site. The remote monitoring device 30 has a communication device 31, recorder 32 and anomaly notifier 33. As described above, the anomaly diagnosis system of this embodiment is formed of the mobile sound-collecting device 15, position detecting device 16, fixed sound-collecting devices 17 and 18, diagnosis device 20 and remote monitoring device 30.

In the diagnosis device 20, the data collecting device 21 collects sound data of an escalator operation sound which is collected by the remote sound-collecting device 15 and/or the fixed sound-collecting devices 17 and 18. The data collecting device 21 further receives detection signals output from the position detecting device 16. Using these collected data and detection signals, the processing device 22 performs calculation processes to determine whether or not an anomaly occurs in the escalator and to estimate the cause of the anomaly when the anomaly has occurred. The recorder 23 records the processing result obtained by the processing device 22 as a diagnosis result. The communication device 24 sends the diagnosis result to the remote monitoring device 30 in the monitoring center via communication line. In the remote monitoring device 30, the communication device 31 receives the diagnosis result from the diagnosis device 20 via communication line. The recorder 32 records the diagnosis result. The anomaly notifier 33 notifies the diagnosis result to an observer at the monitoring center.

In the anomaly diagnosis system of this embodiment, the diagnosis device 20 is provided at the installation site of the escalator being diagnosis target, and the occurrence of the anomaly is determined by the diagnosis device 20, and the diagnosis result is sent to the remote monitoring device 30 in the monitoring center. This reduces processing loads in the remote monitoring device 30. However, when numbers of the escalators to be monitored is low or a data processing ability of the remote monitoring device 30 is sufficiently high, only collecting the sound data may be made in the installation site and diagnosis of the anomaly may be made in the remote monitoring device 30. In this case, the remote monitoring device 30 may have functions of the processing device 22 and recorder 23 of the diagnosis device 20.

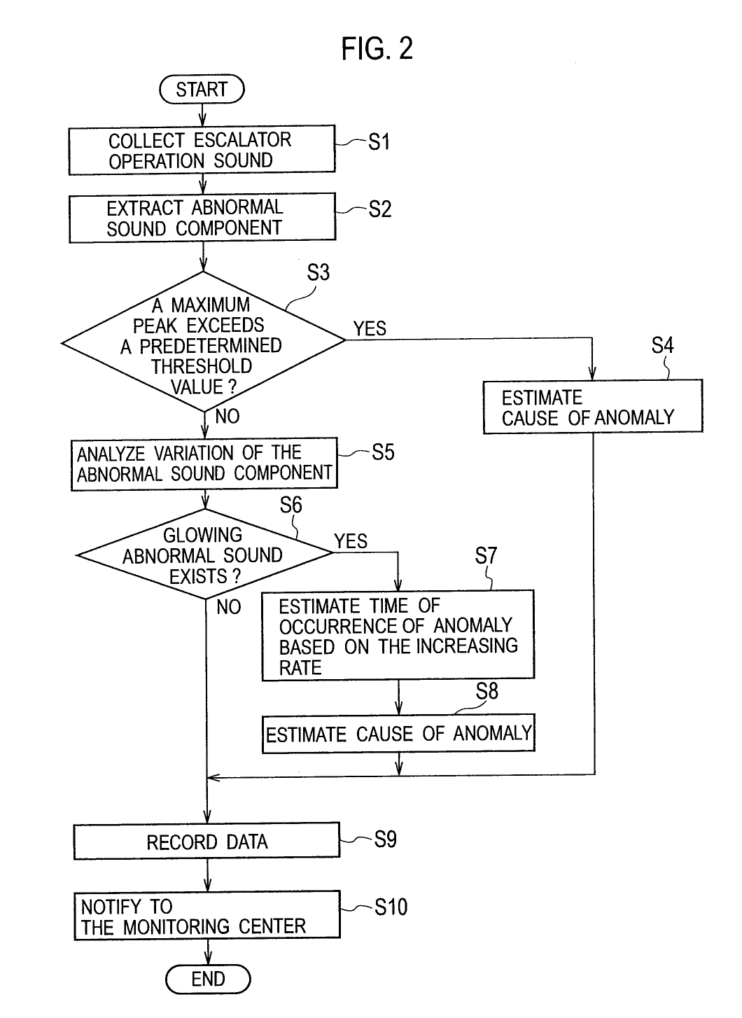

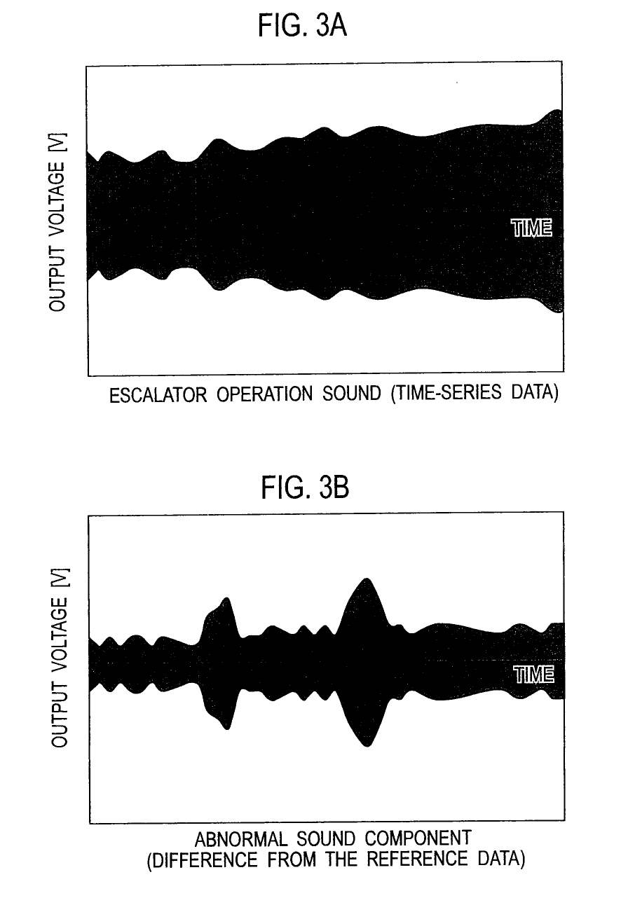

Hereinafter, the operation of the anomaly diagnosis system of this embodiment as described above is explained with reference to FIGS. 2 to 5. FIG. 2 is a flowchart showing a processing procedure performed mainly in the diagnosis device 20. FIGS. 3 to 5 are schematic diagrams showing processes performed in the processing device 22.

In the anomaly diagnosis system of this embodiment, the diagnosis device 20 diagnoses an anomaly in the escalator anomaly diagnosis periodically such as once a day or week, and the like. The diagnosis result is sent to the remote monitoring device 30 in the monitoring center.

When the anomaly diagnosis is made, firstly, the mobile sound-collecting device 15 and fixed sound-collecting devices 17 and/or 18 respectively collects an escalator operation sound while the step 10 is circulated in the circulation path, for example, 3 or 4 times (Step S1). A sound data obtained by the mobile sound-collecting device and/or fixed sound-collecting devices 17 and 18 is collected and stored by the data collecting device 21 of the diagnosis device 20. In this case, a detection signal from the position detecting device 16 is input into the data collecting device 21 in the timing when the inspection step 10A has passed through the reference position. Therefore, the data collecting device 21 recognizes a sound data between previously and presently detected detection signals as a sound data in one circulation of the escalator. The data collecting device 21 stored the sound data in one circulation of the escalator as one unit sound data.

Next, the processing device 22 of the diagnosis device 20 makes the anomaly diagnosis of the escalator using the sound data stored in the data collecting device 21. The processing device 22 makes this anomaly diagnosis in a manner as follows.

The processing device 22 eliminates normal sound components from the sound data of the escalator operation sound stored in the data collecting device 21 to extract abnormal sound components therein (Step S2). Specifically, the sound data includes laud operation sounds of a decelerator such as sound of the decelerator even in a normal condition of the escalator. Therefore, it is difficult to determine an occurrence of an anomaly using the sound data as it is. Accordingly, a sound data in the normal condition having no anomaly is stored in advance like just after the installation of the escalator or the maintenance thereof, and the sound data is referred as a reference data. Only abnormal sound is extracted by calculating a difference between the reference data and the sound data of the escalator operation sound collected in the abnormal condition. In this embodiment, the abnormal sound components as shown in FIG. 3B are extracted from an output waveform of time-series data the escalator operation sound as shown in FIG. 3A by eliminating the reference data with taking into account the frequency characteristics. According to the procedure as described above, it is possible to recognize loudness of the abnormal sound from respective peak heights in the output waveform of the abnormal sound components. In addition, extraction of the abnormal sound components enables one to distinguish the abnormal sound components aurally when the extracted data is played.

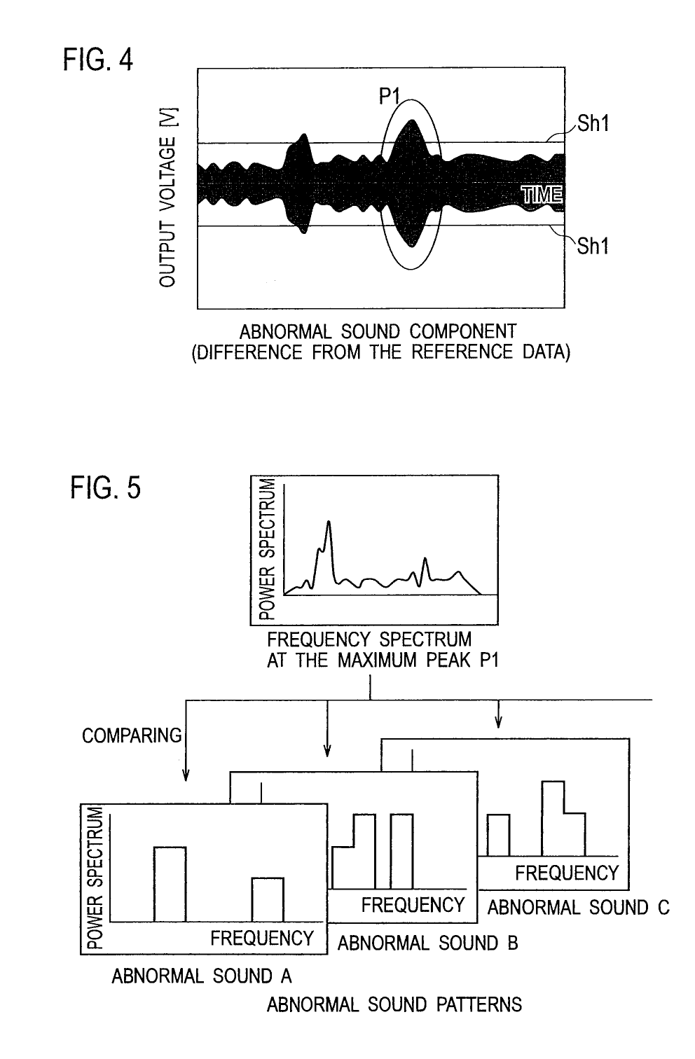

As shown in FIG. 4, the processing device 22 extracts a maximum peak P1 in the output waveform which is extracted as the difference between the reference data and the sound data of the escalator operation sound, and it determines whether or not the maximum value of the peak P1 is higher than a predetermined threshold value Sh1 (Step S3). When the maximum value is higher the threshold value Sh1, it is determined that an anomaly occurs in the escalator and the process moves to a process for estimating the cause of the anomaly (Step S4).

Here, the process for estimating the cause of the anomaly is explained in detail.

The abnormal sound as described above is generated by various causes. It may be caused by: a contact between the step 10 and a side panel disposed at the side of the step 10; the step 10 in passing over a foreign substance on the guide rail or the like; a contact between the step 10 and the platform; interference in inversion of the step 10 passing over the driving sprocket 7 or the driven sprocket 8; a contact between adjacent steps 10, and the like. Further, the abnormal sound may be generated in the balustrades 13. These abnormal sounds have different frequency bandwidths from one another. Thus it is possible to estimate the type of the abnormal sound by specifying a characteristic frequency range of the abnormal sound from the frequency bandwidth. This means that it is possible to estimate the cause of the anomaly generating the abnormal sound. In the anomaly diagnosis system of this embodiment, frequency patterns are made and stored in advance by causes of anomalies generating abnormal sounds. Here, each frequency pattern indicates characteristic frequency components of the abnormal sound, which are expressed by weight functions or the like to indicate characteristic frequency ranges of the abnormal sound. The frequency analysis is performed for the maximum peak P1 and the components nearby that are included in the abnormal sound component extracted from the sound data of the escalator operation sound. Thereafter, as shown in FIG. 5, the result of the frequency analysis is compared with the stored abnormal sound frequency patterns respectively which indicate respective causes of anomalies. In this comparison, correlations between the result and abnormal patterns are evaluated and the most correlated pattern is specified. Consequently, the cause of the anomaly indicated by the most correlated pattern is estimated as an actual cause occurred in the escalator.

As described above, the anomaly in the escalator is detected by processes in the processing device 22 and the cause of the anomaly is estimated. The occurrence of the anomaly and the cause thereof are recorded as a diagnosis result in the recorder 23 (Step S9). In addition, the diagnosis result is sent to the remote monitoring device 30 in the monitoring center via communication line (Step S10).

The communication device 31 of the remote monitoring device 30 receives the diagnosis result from the diagnosis device 20 and the diagnosis result is recorded in the recorder 32. The anomaly notifier 33 notifies the observer in the monitoring center of the diagnosis result by display or phonetic output. In this way, the observer can recognize the occurrence of the anomaly in the escalator being monitored and further recognized the cause of the anomaly. Accordingly, it is possible to select suitable maintenance workers and the numbers thereof. As described above, this enables efficient maintenance operations.

Meanwhile, the sound data of the escalator operation sound collected by the remote sound-collecting device 15 or fixed sound-collecting devices 17 and 18 may includes external sounds such as footsteps of users, environmental sound depending on the sound-collection timing, and the like. Such external sounds are not derived from the escalator operation it self. Therefore, in order to accurately perform the anomaly diagnosis, distinguishing between the external sounds and the actual sound derived from the escalator operation is preferably required to avoid the external sounds to be determined as abnormal sounds generated in the escalator. In this embodiment, as described above, one unit sound data is a sound data collected while the inspection step 10A is circulated once from the reference position in the circulation path, and plural units sound data are stored in the data collecting device 21. The processing device 22 determines the occurrence of the anomaly in a manner as follows. When abnormal sounds appear in the same parts of respective units sound data, which are corresponding to the same position through which the inspection step 10A passes, the processing device 22 determines that the abnormal sounds in the parts are derived from the escalator operation, and extracts the parts of the sound data. On the other hand, when an abnormal sound appears singly in the whole of the units sound data, the processing device 22 determines such abnormal sound not to be derived from the escalator operation. In this way, determination of the occurrence of the anomaly is made using only abnormal sounds derived from the escalator operation.

Further, even in extracted data parts which are considered to include the abnormal sound component derived from the escalator operation sound, the component may be affected by external sounds. The processing device 22 suppresses the affect of the external sounds by averaging the same data parts extracted from respective units sound data, which correspond to the same position of the inspection step 10A. For example, FIG. 4 shows one of the maximum peaks P1 appeared in respective data parts extracted from respective units sound data. The maximum peaks P1 are averaged and the averaged peak value is compared with the predetermined threshold value Sh1 to determine the occurrence of the anomaly. When it is determined that the anomaly occurs, frequency analysis may be performed for respective data parts extracted from respective units sound data, and the estimation of the cause of the anomaly may be made using the averaged values of the power spectra of the data parts.

When a maximum peak P1 has the threshold value Sh1 or lower in Step S3 as described above, a process is proceeded as follows.

When the maximum peak P1 has the threshold value Sh1 or lower, the processing device 22 determines that no anomaly presently occurs in the escalator, and analyzes variation of the abnormal sound components in comparison with former sound data (Step S5). Specifically, numerous output waveforms of abnormal sounds obtained when no occurrence of anomaly is determined are stored in the recorder 23. The processing device 22 analyzes variation of plural peaks including the maximum peak P1 by comparing the waveform of anomaly sound components used in the present anomaly diagnosis with waveforms used in the former anomaly diagnoses. The processing device 22 determines whether or not a glowing peak exists in the present waveform in comparison with the former waveforms (Step S6). As the result, when no glowing peak exists, the recorder 23 records the present waveform used in the anomaly diagnosis (Step S9), and the communication device 24 sends the diagnosis result indicating no anomaly in the escalator to the remote monitoring device 30 in the monitoring center via communication line (Step S10).

On the other hand, when a glowing peak is found in the determination in Step S6, the processing device 22 estimates the time when the anomaly will occur. In other words, the processing device 22 estimates the time when the peak will become higher than the threshold value Sh1 based on the glowing rate of the peak (Step S7). Thereafter, the processing device 22 performs a frequency analysis for components of the sound data at and around the glowing peak, and estimates the cause of the anomaly, which is considered to occur later, in the manner as already described above (Step S8).

When the processing device 22 estimates both the time of the occurrence of anomaly in the escalator and the cause thereof by the above-described process, the recorder 23 records the time and cause as a diagnosis result (Step S9). In addition, the communication device 24 sends the diagnosis result to the remote monitoring device 30 in the monitoring center via communication line (Step S10).

The communication device 31 of the remote monitoring device 30 receives the diagnosis result from the diagnosis device 20, and the diagnosis result is recorded in the recorder 32. The anomaly notifier notify the observer in the monitoring center of the diagnosis result by display or phonetic output. In this way, the observer can recognize a sign of the anomaly in the escalator, the time when the anomaly will occurs, and the cause of anomaly. Therefore, based on this result, it is possible to select maintenance workers suitable for the anomaly and the numbers thereof, and also possible to determine the time when the maintenance operation should be made. Accordingly, the efficient maintenance operation is possible. When the time of next scheduled maintenance operation is prior to the time when the anomaly will occurs, it is possible to prompt the maintenance worker to check suspicious portions for the anomaly. In addition, if parts will be need for repairing, it is possible to prepare the parts in advance.

As described above with reference to the concrete example, in the anomaly diagnosis system of this embodiment, the processing device 22 of the diagnosis device 20 determines whether or not an anomaly occurs in the escalator and also estimate the cause of the anomaly. Accordingly, it enables early detection of anomalies and prompt responses therefor. Further, the causes of the anomalies can be recognized in advance, for example, before visiting the installation site, thus enabling suitable responses therefor. Consequently efficient maintenance operations can be achieved.

In the anomaly diagnosis system of this embodiment, when the processing device 22 of the diagnosis device 20 determines whether or not an anomaly occurs, the determination is made based on whether or not the maximum peak P1 of the output waveform of the abnormal sound component which is extracted from the sound data of escalator operation sound. Accordingly, the determination can be made simply but accurately.

In addition, when the escalator has no anomaly but has a sign which may result in an anomaly, the processing device 22 detects the sign and estimates the time of occurrence of the anomaly. Therefore, it is possible to reflect such result to the future plan of maintenance operation to perform it efficiently.

Further, in determining an anomaly, the processing device 22 extracts abnormal sound components being generated at the same position in the escalator from sound data of the escalator operation sounds obtained in multiple circulations of the escalator. Thereafter, the processing device 22 determines the anomaly based on the extracted abnormal sound components. Therefore, accurate determination of the anomaly becomes possible by excluding effects due to sudden external sounds. In addition, the extracted abnormal sound components are averaged, and the averaged component is used for determination of the anomaly and estimation of the cause thereof. Accordingly, effects due to the external sounds are more effectively excluded, thus very accurate anomaly diagnosis can be performed.

### Second Embodiment

Next, a second embodiment according to the present invention will be explained hereinafter. This embodiment is exemplary modification of the determination process of an anomaly performed by the processing device 22 of the diagnosis device 20. Note, the configuration of the diagnosis device 20 and other processes except of the determination process are the same as those of the first embodiment as described above. Hereinafter, only the determination process characterized by the second embodiment will be explained in detail with omitting explanations for other parts overlapped with the first embodiment.

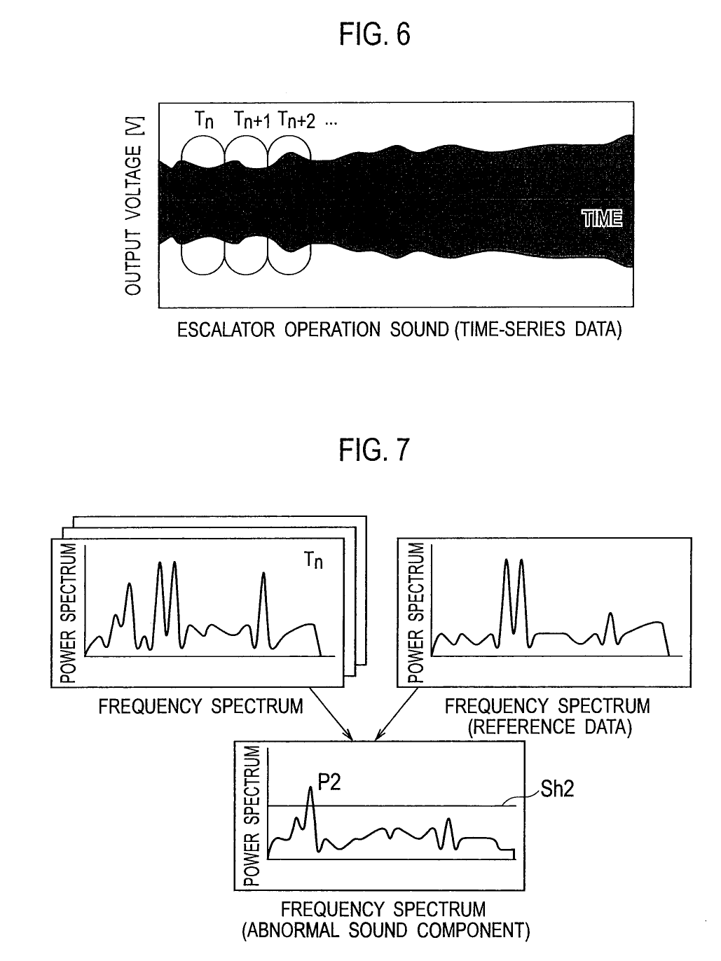

FIGS. 6 and 7 shows an outline of the determination process performed by the processing device 22 of the diagnosis device 20 in the anomaly diagnosis system according to the second embodiment.

In this embodiment, when the processing device 22 determines an occurrence of it performs frequency analysis for sound data of the escalator operation sound, which is stored in the data collecting device 21, by predetermined time divisions Tn, Tn+1, Tn+2 . . . , and obtains respective frequency characteristics thereof (see FIG. 6). Similarly, the processing device 22 performs the frequency analysis for for the pre-stored reference data (i.e. sound data in normal operation) to obtain frequency characteristics thereof.

Next, as shown in FIG. 7, a difference between the frequency analysis results on the reference data and the sound data of the escalator operation sound is extracted. For more detail, only abnormal sound frequency characteristic is obtained by subtracting a power spectrum of the reference data from a power spectrum of the frequency components of the escalator operation sound. Thereafter, a maximum value of a peak of the power spectrum (hereinafter referred as a maximum frequency peak P2) is specified from this abnormal sound frequency characteristic, and an occurrence of an anomaly is determined based on whether or not the maximum frequency peak P2 is higher than the predetermined threshold value Sh2.

When the maximum frequency peak P2 is higher than the threshold value Sh2, the processing device 22 determines that an anomaly has been occurred, and estimates the cause of the anomaly with the processes as described in the first embodiment. On the other hand, when the maximum frequency peak P2 has the threshold value Sh2 or lower, the processing device 22 performs the analysis for the variation of the abnormal sound components and the time estimation of the occurrence of the anomaly with the same manner of the first embodiment. Thereafter, the diagnosis result is sent to the remote monitoring device 30 in the monitoring center.

As described above, according to this embodiment, in determination of an occurrence of an anomaly, the processing device 22 of the diagnosis device 20 extracts only a frequency characteristic of the abnormal sound component by calculating a difference between frequency analysis results on the reference data and sound data of the escalator operation sound. Further, the processing device 22 determines the anomaly based on whether or not the maximum frequency peak P2 of the frequency characteristic of the abnormal sound component is higher than the predetermined threshold value Sh2. Accordingly, the determination of the anomaly can be performed simply but accurately.

The above first and second embodiments show examples employing the present invention. Therefore, the explanations of these embodiments do not mean to limit the scope of the present invention by themselves. The scope of the present invention may involve various modifications easily derivable from this disclosure.

What is claimed is:

1. An anomaly diagnosis system for a passenger conveyor configured to convey a passenger on one of a plurality of steps connected to each other in an endless manner, by circulating the plurality of steps, the anomaly diagnosis system comprising:
a sound-collecting device configured to collect an operation sound of the passenger conveyor;
an anomaly determining device configured to store a reference sound data of an operation sound of the passenger conveyor in normal operation and to determine an occurrence of an anomaly based on a difference between the reference sound data and a sound data of the passenger conveyor operation sound collected by the sound-collecting device; and
a cause estimation device configured to have frequency patterns indicating characteristic frequency components of abnormal sounds in the passenger conveyor by factors causing the abnormal sounds, and further configured to estimate a cause of the anomaly by comparing a frequency analysis result of the difference with the reference sound data.

2. The anomaly diagnosis system according to claim 1, wherein the anomaly determining device extracts the difference and determines the occurrence of the anomaly based on whether or not the extracted difference is higher than a predetermined threshold value.

3. The anomaly diagnosis system according to claim 1, wherein the anomaly determining device extracts, as the difference, a difference between results from frequency analysis on the reference data and sound data, and determines the occurrence of the anomaly based on whether or not the extracted difference is higher than a predetermined threshold value.

4. The anomaly diagnosis system according to claim 2, wherein, when the peak of the difference has the threshold value or less and is increasing than a peak of previously-extracted difference, the anomaly determining device estimates time for the peak of the difference to exceed the threshold value based on an increasing rate of the peak.

5. The anomaly diagnosis system according to claim 3, wherein, when the peak of the difference has the threshold value or less and is increasing than a peak of previously-extracted difference, the anomaly determining device estimates time for the peak of the difference to exceed the threshold value based on an increasing rate of the peak.

6. The anomaly diagnosis system according to claim 1, wherein the sound-collecting device is provided in at least one of the plurality of steps so as to collect the passenger conveyor operation sound with circulating with the step.

7. The anomaly diagnosis system according to claim 6, further comprising a position detecting device configured to detect a position of the step provided with the sound-collecting device.

8. The anomaly diagnosis system according to claim 7, wherein, when the sound data of the passenger conveyor operation sound is collected as one unit by the sound-collecting device in one circulation of the step provided with the sound-collecting device, the sound-collecting device collects the passenger conveyor operation sound with plural units; and when the sound data of the passenger conveyor operation sound in each unit has a difference from the reference data at the same position in the circulation path of the step, the anomaly determining device extracts at least one data part corresponding to the position from the sound data, and determines the occurrence of the anomaly for the extracted data part.

9. The anomaly diagnosis system according to claim 8, wherein the anomaly determining device extracts and averages the data parts from the sound data in the plural units, and determines the occurrence of the anomaly based on the averaged data parts.
